(19) United States
(12) Patent Application Publication
(10) Pub. No.: US 2015/0256042 A1
(43) Pub. Date: Sep. 10, 2015

(54) MICRO MOTOR ROTOR SUPPORT

(71) Applicant: DONGCHANG MOTOR (SHENZHEN) CO., LTD., Shenzhen, Guangdong (CN)

(72) Inventors: Muting Li, Shenzhen (CN); Juhua Pi, Shenzhen (CN)

(73) Assignee: DONGCHANG MOTOR (SHENZHEN) CO., LTD., Shenzhen, Guangdong (CN)

(21) Appl. No.: 14/365,998

(22) PCT Filed: May 2, 2013
(86) PCT No.: PCT/CN2013/075091

§ 371 Date: Jun. 17, 2014

(30) Foreign Application Priority Data
Mar. 25, 2013 (CN) 201310097286.5

(51) Int. Cl. H02K 5/04

(52) U.S. Cl. CPC H02K 5/04

(57) ABSTRACT

Disclosed is a micro motor rotor support, which comprises a support frame, a shaft sleeve and a fastening ring, said support frame comprising a top plate which has an accepting hole, said shaft sleeve being mounted in the accepting hole, said fastening ring being mounted on the shaft sleeve and fixed on the top plate and its opening having at least one inclined spring sheet formed on an inner edge thereof, said spring sheet contacting with and applying pressing force to an outer surface of said shaft sleeve. The outer surface of said shaft sleeve has at least one groove, and said fastening ring or top plate has at least one projection which is locked into the groove. In the present invention, the shaft sleeve can be prevented from rotating with the rotor effectively and can be adjusted freely to keep coaxial with the rotation axis of the rotor.

### FIELD OF THE INVENTION

The present invention relates to a micro motor, and more particularly relates to a micro motor rotor support.

### BACKGROUND OF THE INVENTION

In an existing micro motor, it includes two rotor supports provided at two side ends of its motor rotor, respectively. Each rotor support has a shaft sleeve and the rotation axis of the motor rotor will be mounted into the two shaft sleeves, thereby finishing the setting of the motor rotor. Referring to FIG. 1, it shows a structure of an existing rotor support used for a micro motor. This rotor support includes a support frame 11, a shaft sleeve 13 and a fastening ring 15, and the support frame 11 includes a top plate 110 which extends down from its two side ends to form a support arm 111, respectively. Each of the two support arms 111 extends out from its bottom end to form a support plate 112 which is substantially parallel to the top plate 110. There is a primarily spherical accepting hole 113 provided at the central location of the top plate 110. The shaft sleeve 13 is mounted into the accepting hole 111 and fixed by means of the fastening ring 15.

As shown in FIG. 1, in the existing technology, the fastening ring 15 has more than one spring sheet 150, all of which are uniformly distributed along the inner edge of its opening. These spring sheets 150 are provided for applying pressing force to an outer surface of the shaft sleeve 13, thereby positioning the shaft sleeve 13. In the above fastening ring 15, its spring sheets 150 needs to be designed to have enough pressing force so as to position the shaft sleeve. Thus, it generally will bring a problem that the pressing force applied to the shaft sleeve by the fastening ring 15 is too much, which is not good for the shaft sleeve to be adjusted freely so as to keep coaxial with the rotation axis of the rotor, in result, it is likely to bring some phenomenon, such as instability of power, sticking, unusual noise and vibration when the assembled micro motor is working.

Ideally, when the shaft sleeve is disposed on the support frame, it needs to be prevented from rotating with the rotor and be adjusted freely to keep coaxial with the rotation axis of the rotor. However, the shaft sleeve which has the above structure can hardly meet its above set up requirement. If the pressing force applied to the shaft sleeve by the spring sheets is enough, the shaft sleeve can be prevented from rotating with the rotor, but it is not good for the shaft sleeve to be adjusted freely so as to keep coaxial with the rotation axis of the rotor. And if the pressing force applied to the shaft sleeve by the spring sheets is not enough, it is good for the shaft sleeve to be adjusted freely so as to keep coaxial with the rotation axis of the rotor, but the shaft sleeve will rotate with the rotor.

### SUMMARY OF THE INVENTION

One technical problem that the present invention tries to solve is to provide a micro motor rotor support having a shaft sleeve which can be prevented from rotating with the rotor and can be adjusted freely to keep coaxial with the rotation axis of the rotor.

To solve the above technical problem, the present invention adopts the following technical solution: a micro motor rotor support comprises a support frame, a shaft sleeve and a fastening ring, said support frame comprising a top plate which has an accepting hole formed thereon, said shaft sleeve being mounted in the accepting hole, said fastening ring being mounted on the shaft sleeve and fixed on the top plate and its opening having at least one inclined spring sheet formed on inner edge thereof, said spring sheet contacting with and applying pressing force to outer surface of said shaft sleeve. The outer surface of said shaft sleeve is concave partly to form at least one groove, said fastening ring or top plate has at least one projection formed thereon and said projection is locked into the groove.

In the above micro motor rotor support, said groove is formed on the outer surface of said shaft sleeve in an axial direction.

In the above micro motor rotor support, said groove is formed on the outer surface of said shaft sleeve with two through openings.

In the above micro motor rotor support, said top plate extends down from its two side ends to form two support arms, respectively, and each support arm extends out from its bottom end to form a support plate.

In the above micro motor rotor support, said support plate is parallel with said top plate.

In the above micro motor rotor support, said projection is formed on the inner edge of the opening of said fastening ring.

In the above micro motor rotor support, each of two sides of said projection has a side baffle formed thereon.

In the above micro motor rotor support, said projection is formed on an inner sidewall of said accepting hole.

In the above micro motor rotor support, the number of said spring sheet is two or three; the number of said groove is one or two; and the number of said projection is the same as that of said groove.

In the above micro motor rotor support, a difference between a width of said projection and a width of said groove is 0.1-0.3 mm.

The present invention has the following advantages: the outer surface of the shaft sleeve is concave partly to form at least one groove thereon and the fastening ring or top plate has at least one projection formed thereon. The projection is locked into the groove so as to provide a function of positioning the shaft sleeve. Thus, it can prevent the shaft sleeve effectively from rotating with the rotor and also can reduce the pressing force applied to the shaft sleeve by the spring sheet so that the shaft sleeve can be adjusted freely to keep coaxial with the rotation axis of the rotor. Thus, it can solve the dilemma of the setting of the shaft sleeve of the existing micro motor rotor support and help to improve the quality of the micro motor.

### BRIEF DESCRIPTION OF THE DRAWINGS

FIG. 1 is a structure diagram of an existing micro motor rotor support;

FIG. 2 is a structure diagram of a micro motor to which the present invention is applied;

FIG. 3 is a perspective view of the present invention according to a first embodiment;

FIG. 4 is an exploded view of the present invention according to the first embodiment;

FIG. 5 is a perspective view of the present invention according to a second embodiment;

FIG. 6 is an exploded view of the present invention according to the second embodiment;

FIG. 7 is a perspective view of the present invention according to a third embodiment; and

FIG. 8 is an exploded view of the present invention according to the third embodiment.

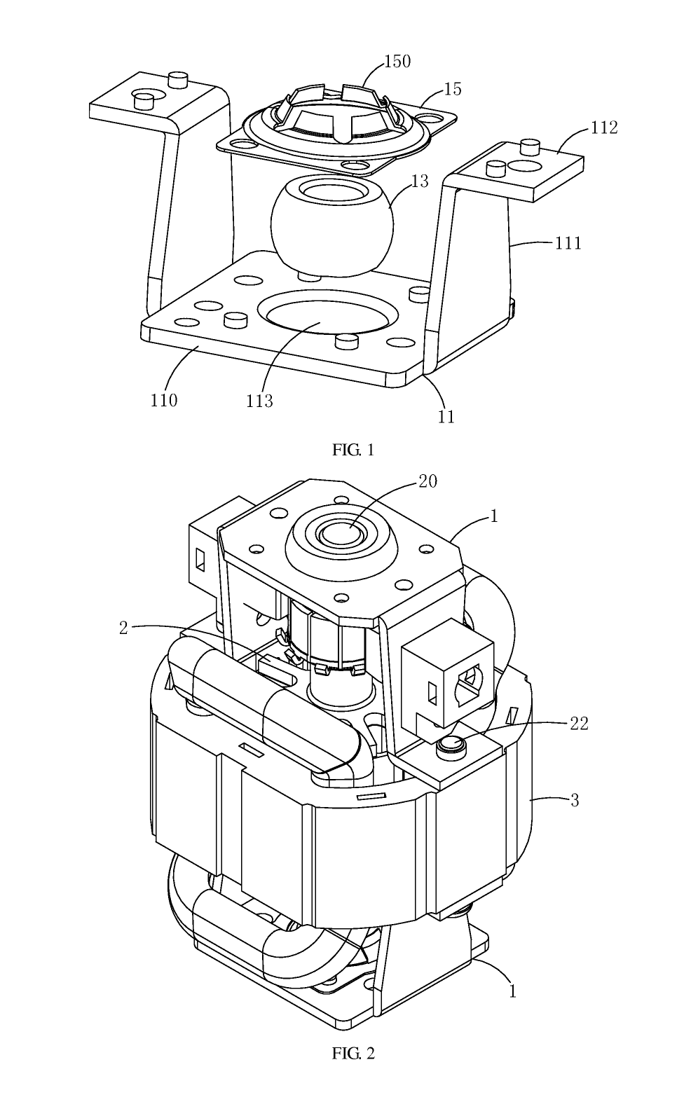

### DETAILED DESCRIPTION OF ILLUSTRATED EMBODIMENTS

The following illustration combining the accompanying drawings and embodiments will facilitate a clear understanding of the object, technical solution and advantages of the present invention for an ordinary person skilled in the art.

Referring to FIG. 2, a rotor support 1 disclosed by the present invention is applied to a micro motor and taken as an indispensable part of the micro motor. Generally, each end of the rotor 2 of the micro motor has one rotor support 1 provided thereon for installing the rotation axis 20 of the rotor 2, thereby finishing the installation of the rotor 2.

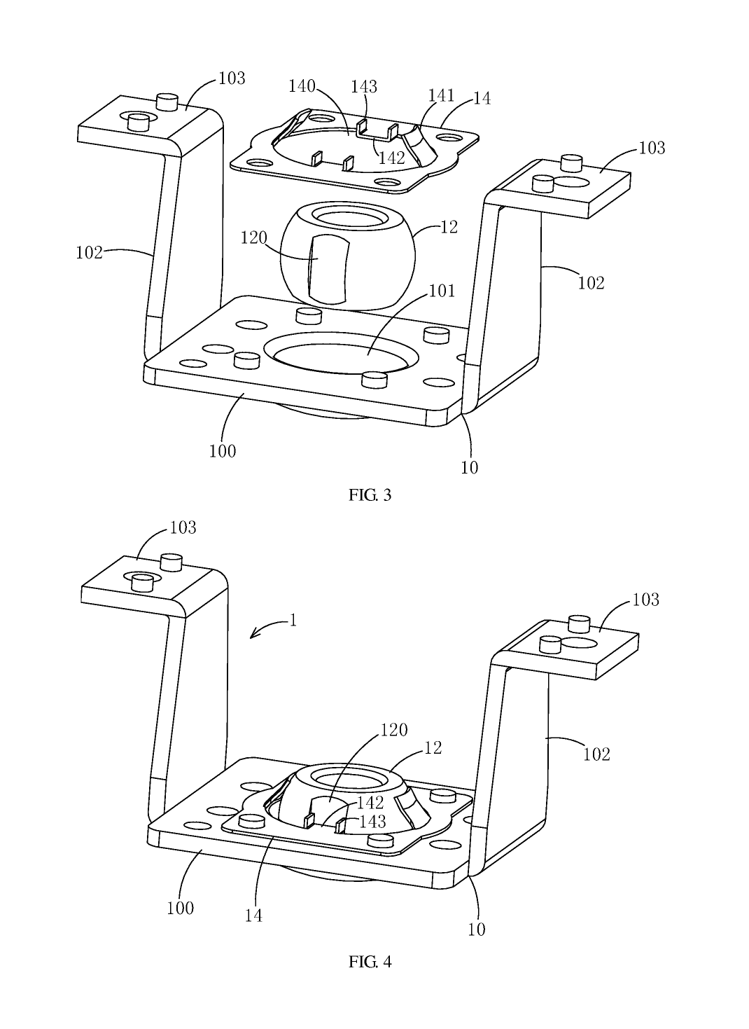

Referring to FIG. 3 and FIG. 4, a first embodiment of the present invention will be described. In this embodiment, the micro motor rotor support 1 includes a support frame 10, the support frame 10 includes a top plate 100 and there is an accepting hole 101 formed at a central location of the top plate 100. The accepting hole 101 is used for holding a shaft sleeve 12 and provided for the installation of the shaft sleeve 12. Preferably, the shaft sleeve 12 is generally designed to be a drum-shaped structure, and the accepting hole 101 is designed to be a spherical structure which protrudes from the top surface of the top plate 100, so as to assist the shaft sleeve 12 to be installed.

As shown in figures, the support frame 10 includes a top plate 100. The top plate 100 extends down from its two side ends to form a support arm 102, respectively, and each support arm 102 extends out from its bottom end to form a support plate 103 which is substantially parallel to the top plate 100. As shown in FIG. 2, when installing, two support plates 103 are supported by a stator 3 of the micro motor and fixed on the stator 3 via a fastener 22, such as screw, so as to achieve a firm installation of the rotor support 1.

The shaft sleeve 12 is mounted into the accepting hole 101 and is pressed and fixed thereon via a fastening ring 14. Referring to FIG. 3 and FIG. 4, the fastening ring 14 has two opposite and inclined spring sheets 141 formed on an inner edge of an opening 140 of the fastening ring 14. The shaft sleeve 12 is disposed in the accepting hole 101, and the fastening ring 14 is mounted on the shaft sleeve 12 and fixed on the top plate 100, for example, by means of riveting to realize a fixed connection of them. The spring sheets 141 contact with and apply pressing force to the outer surface of the shaft sleeve 12, so as to make the shaft sleeve 12 be fixed on the top plate 100. Preferably, the opening 140 is designed to be ring-shaped, so as to match with the drum-shaped structure of the shaft sleeve 12.

Referring to FIG. 3 and FIG. 4, the outer surface of the shaft sleeve 12 has concaves which are provided to form two opposite grooves 12 in an axial direction, and the opening 140 of the fastening ring 14 has two opposite projections 142 formed on its inner edge. When the fastening ring 14 is assembled with the shaft sleeve 12, two projections 142 are locked into two grooves 12, respectively; thus, each projection 142 is capable of stopping a rotation of the shaft sleeve 12, by means of the cooperating relationship between the side end of the projection 142 and the inner sidewall of the groove 120. Thus, it can prevent the shaft sleeve 12 from rotating with the rotor when the mini-type motor is working. Furthermore, because the projection 142 can move in the groove 120 in an axial direction, which will not stop the shaft sleeve 12 from being adjusted in an axial direction, the shaft sleeve 12 can be adjusted freely to keep coaxial with the rotation axis 20 of the rotor 2. Preferably, each of two sides of the projection 142 has a side baffle 143 formed thereon, respectively. By means of the baffle 143, a contact area of the projection 142 and the inner sidewall of the groove 120 is increased, so that the projection 142 can position the shaft sleeve 12 more steadily. In the embodiments shown in figures, the groove 120 is formed on the outer surface of the shaft sleeve 12 with two through openings, and it can be formed by processing, such as punching the outer surface of the shaft sleeve 12. The groove 120 is designed to be a structure shown in figures, so that the projection 142 is easy to be disposed into the groove 120 and it is convenient for assembly between each component of the rotor support 1.

The projection 142 has a width which is slightly less than the width of the groove 120, thereby the projection 142 can move freely in the groove 120 in an axial direction. Preferably, the difference between the width of the projection 142 and that of the groove 120 is 0.1-0.3 mm.

In the present invention, the shaft sleeve 12 is positioned by means of the cooperation between the projection 142 and the groove 120, thereby preventing the shaft sleeve 12 from rotating with the rotor. Thus, the pressing force applied to the shaft sleeve 12 by the spring sheets 141 can be reduced, so that the shaft sleeve 12 can be adjusted freely to keep coaxial with the rotation axis 20 of the rotor 2. By means of reducing the number of spring sheets 141 and reducing the contact area between the spring sheet 141 and shaft sleeve 12, the pressing force applied to the shaft sleeve 12 by the fastening ring 14 can be reduced.

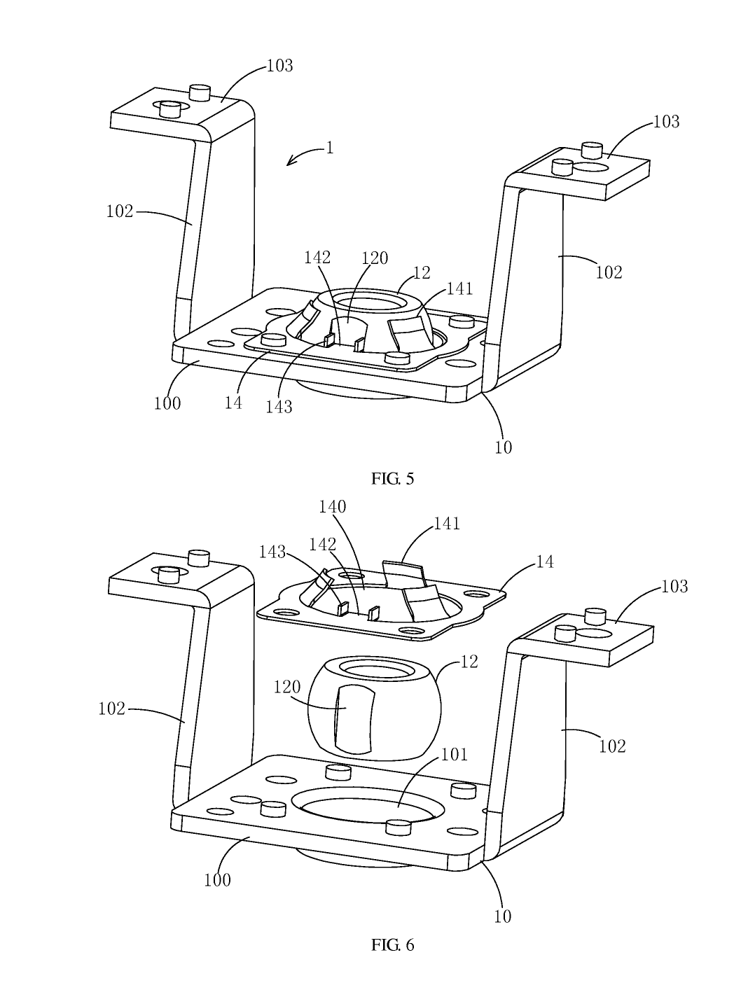

The second embodiment of the present invention will be described by combining with FIG. 5 and FIG. 6. In this embodiment, the micro motor rotor support 1 includes a support frame 10, a shaft sleeve 12 and a fastening ring 14. The fastening ring 14 has three inclined spring sheets 141 uniformly distributed on the inner edge of its opening 140. These spring sheets 141 contact with and apply pressing force to the outer surface of the shaft sleeve 12, so as to make the shaft sleeve 12 be fixed on the top plate 100. The outer surface of the shaft sleeve 12 has a concave which is provided to form one groove 12 in an axial direction, and the opening 140 of the fastening ring 14 has one projection 142 formed on its inner edge. The projection 142 is locked into the groove 12, so as to position the shaft sleeve 12, thus, it can prevent the shaft sleeve 12 from rotating with the rotor. The difference between this embodiment and the first embodiment is the number of the spring sheets 141, the projection 142 and the groove 120.

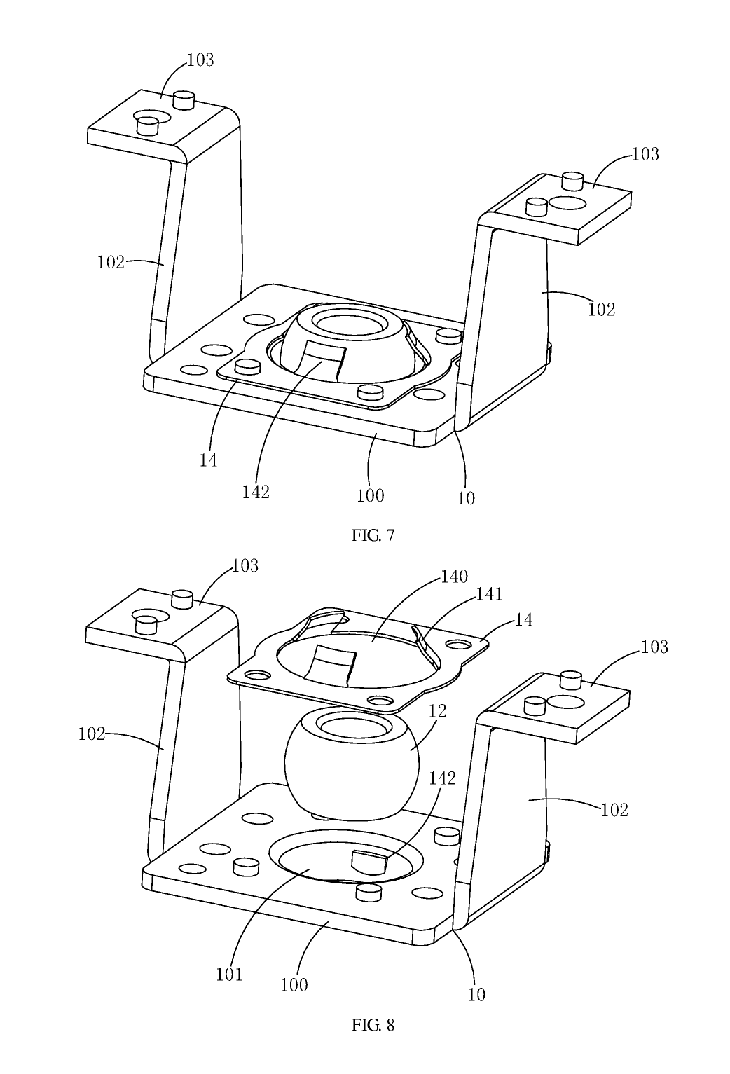

The third embodiment of the present invention will be described by combining with FIG. 7 and FIG. 8. In this embodiment, the micro motor rotor support 1 includes a support frame 10, a shaft sleeve 12 and a fastening ring 14. The fastening ring 14 has three inclined spring sheets 141 uniformly distributed on the inner edge of its opening 140. These spring sheets 141 contact with and apply pressing force to the outer surface of the shaft sleeve 12, so as to make the shaft sleeve 12 be fixed on the top plate 100. The outer surface of the shaft sleeve 12 has a concave which is provided to form one groove (not shown in the figures) in an axial direction, and the accepting hole 101 of the top plate 100 has one projection 142 formed on its inner sidewall. The projection 142 is locked into the groove 12, so as to provide a function of positioning the shaft sleeve 12, thus, it can prevent the shaft sleeve 12 from rotating with the rotor. Nevertheless, it should be understood that the projection also can be provided on any other suitable location of the top plate 100. The difference between this embodiment and the second embodiment is that the projection 142 is provided on a different location of the rotor support 1 and has a different structure and shape.

As mentioned above, for the micro motor rotor support of the present invention, the outer surface of its shaft sleeve 12 is concave partly to form at least one groove 120 thereon and the fastening ring 14 or top plate 100 has at least one projection 142 formed thereon. The projection 142 is locked into the groove 120 so as to provide a function of positioning the shaft sleeve 12. Thus, it can prevent the shaft sleeve 12 from rotating with the rotor and also can reduce the pressing force applied to the shaft sleeve 12 by the spring sheet 141 so that the shaft sleeve 12 can be adjusted freely to keep coaxial with the rotation axis 20 of the rotor 2. And then it can solve the dilemma of the setting of the shaft sleeve of the existing micro motor rotor support and help to improve the quality of the micro motor.

Above descriptions of embodiments are provided for illustrating the present invention, so as to facilitate understanding and it is to be understood that the invention is not to be limited to the disclosed embodiments. Any technique extension and recreation according to the present invention should be included within the scope of protection of the invention.

What is claimed is:

1. A micro motor rotor support, comprising a support frame (10), a shaft sleeve (12) and a fastening ring (14), said support frame (10) comprising a top plate (100) which has an accepting hole (101) formed thereon, said shaft sleeve (12) being mounted in the accepting hole (101), said fastening ring (14) being mounted on the shaft sleeve (12) and fixed on the top plate (100), said fastening ring (14) having an opening (140) which has at least one inclined spring sheet (141) formed on inner edge of the opening (140), said spring sheet (141) contacting with and applying pressing force to outer surface of said shaft sleeve (12), wherein the outer surface of said shaft sleeve (12) is concave partly to form at least one groove (12), said fastening ring (14) or top plate (100) has at least one projection (142) formed thereon and said projection (142) is locked into the groove (12).

2. The micro motor rotor support according to claim 1, wherein said groove (120) is formed on the outer surface of said shaft sleeve (12) in an axial direction.

3. The micro motor rotor support according to claim 2, wherein said groove (120) is formed on the outer surface of said shaft sleeve (12) with two through openings.

4. The micro motor rotor support according to claim 1, wherein said top plate (100) extends down from two side ends thereof to form two support arms (102), respectively, and each support arm (102) extends out from a bottom end thereof to form a support plate (103).

5. The micro motor rotor support according to claim 4, wherein said support plate (103) is parallel with said top plate (100).

6. The micro motor rotor support according to claim 1, wherein said projection (142) is formed on the inner edge of the opening (140) of said fastening ring (14).

7. The micro motor rotor support according to claim 6, wherein each of two sides of said projection (142) has a side baffle (143) formed thereon.

8. The micro motor rotor support according to claim 1, wherein said projection (142) is formed on inner sidewall of said accepting hole (101).

9. The micro motor rotor support according to claim 1, wherein the number of said spring sheet (141) is two or three; the number of said groove (120) is one or two; and the number of said projection (142) is the same as that of said groove (120).

10. The micro motor rotor support according to claim 1, wherein a difference between a width of said projection (142) and a width of said groove (120) is 0.1-0.3 mm.
